(19) United States
(12) Patent Application Publication
(10) Pub. No.: US 2001/0056385 A1
(43) Pub. Date: Dec. 27, 2001

(54) Fastener retailing method with graphic interface selection and locator software

(76) Inventors: John Timms, Toronto (CA); Michael Feder, Aurora (CA)

Correspondence Address: Bhupinder S. Randhawa, Bereskin & Parr, Box 401, 40 King Street West, Toronto, ON, M5H 3Y2, CA

(21) Appl. No.: 09/886,014

(22) Filed: Jun. 22, 2001

Related U.S. Application Data
(60) Provisional application No. 60/213,152, filed on Jun. 22, 2000.

(51) Int. Cl. G06F 17/60

(52) U.S. Cl. 705/27; 705/28; 705/1

(57) ABSTRACT

A method for vending fasteners to retail consumers. The fasteners are stocked at a retail outlet in pre-determined locations that are readily identifiable by visible location identifiers. Consumers use software that provides information about the fasteners to facilitate selecting an appropriate fastener product and finding it at the retail outlet. The software is executed by a computer having a graphic interface means for receiving user input. The graphic interface means also displays images of the fasteners and information about their nature and uses. The graphic interface means also displays the location identifiers so the consumers can readily locate the selected fasteners. The consumers are provided public access to the fasteners for self-service shopping prior to payment. In one embodiment the graphic interface means includes a touch screen located at the retail outlet. In an alternate embodiment the graphic interface means includes a personal computer, a monitor and an input device located remote from the retail outlet.

### FIELD OF THE INVENTION

This invention relates to the hardware trade, more particularly to the retailing of fastener products.

### BACKGROUND OF THE INVENTION

The vending of fasteners and related hardware items to retail consumers presents significant challenges that are not generally encountered in retailing other goods. Fasteners include numerous different types of products such as screws, bolts, nuts, washers, hooks, rivets, wall anchors, and so forth, most of which come in numerous different varieties, sizes and materials. Screws alone can account for over one thousand different specific products in a retailer's stock, coming in different lengths and different diameters, with different thread sizes, different shaped heads, different drives, and made of different materials, including plain steel, coated steels, galvanized steel, stainless steel, brass, and so forth.

Many fastener products are better for some applications, and not well suited for other uses. Typically, consumers are not fully versant with all of the different varieties of fastener products available, and therefore have difficulty selecting the most appropriate product, or even matching or mating one to a specific product that they have brought with them to the retail outlet as a reference.

Even when the appropriate fastener product is known, it is often a very time consuming process for the consumer at a self-serve retail outlet to find where the product is located. Although retailers and their fastener suppliers may provide various shelf displays to assist consumers, the products can be organized in very different arrangements at different retail outlets so much time can still be required for a consumer to familiarize himself with the stocking arrangement at a particular retail outlet before he is able to locate the particular fastener product that he is seeking.

Moreover, the difficulties facing the consumer have been exacerbated by recent retail trends that have largely shifted sales of such products from small local hardware stores to very large home improvement centers. These warehouse-like facilities typically provide much broader product lines than does a local hardware store, so while there is a greater likelihood that a specific fastener product will be stocked by the home improvement center than by a small local hardware store, there is also a greater likelihood that a specific fastener product will be more difficult to locate amidst the numerous other similar products.

In both types of retail environments, a consumer may try to seek guidance from the sales staff in identifying or selecting an appropriate fastener product, and in locating it within the store. However, individual consumer purchases of fastener products are generally for relatively low dollar amounts. The cost to the retailer of having sales staff readily available to provide time consuming consultation to consumers can have a significant negative impact on the profitability of selling such “small ticket” items.

It is therefore an object of the present invention to obviate or mitigate these and other disadvantages associated with known ways of vending fasteners to retail consumers.

### SUMMARY OF THE INVENTION

According to the present invention, a method is provided for vending fasteners to retail consumers. The method includes three main steps: stocking the fasteners in a particular manner; providing consumers with computer software to facilitate selecting and locating the fasteners; and allowing consumers public access to the fasteners. In the stocking of the fasteners, numerous varieties of fasteners are stocked at a retail outlet in pre determined locations that are readily identifiable by a visible retail location identifier. Consumers are provided with access to merchandising software that is executed by a computer having a graphic interface means. This receives user input and also displays images of the fasteners and information on the nature and uses of the fasteners. It also displays the retail location identifiers corresponding to the pre-determined locations in which the fasteners are stocked at the retail outlet. The consumers are then allowed public access to the fasteners at the retail outlet for self service shopping prior to payment.

Preferably, the fasteners are stocked at the retail outlet in pre-determined containers that are readily identifiable by a visible container identifier, and the graphic interface means also displays the container identifiers. In a preferred embodiment, the graphic interface means includes a touch screen located at the retail outlet. In an alternate embodiment, the graphic interface means includes a mouse-controlled personal computer and a monitor, and the software is provided to the consumers either on a pre-recorded storage medium or by means of a global computer network so that it may be used remote from the retail outlet.

Advantageously, the images, information, and retail location identifiers and container identifiers are presented on pages organized according to fastener varieties, and the user input determines the selection of the pages. Most advantageously, the graphic interface means also displays full motion videos demonstrating the use of the fasteners.

According to another aspect of the present invention, a method is provided for retail consumers to purchase fasteners. The method includes accessing merchandising software executed by a computer having graphic interface means for receiving user input and for displaying images of numerous varieties of fasteners stocked at a retail outlet in pre-determined locations readily identifiable by a visible retail location identifier, and displaying information on the nature and use of the images, and also displaying the retail location identifiers corresponding to the pre-determined locations in which the fasteners are stocked.

The merchandising software is used to select an appropriate fastener for purchase and to determine its location at the retail outlet. The purchaser then shops for the fastener he has selected by attending a publically accessible location where the fastener is stocked at the retail outlet, which the purchaser identifies by the visible retail location identifier.

Another aspect of the invention provides a method of vending fasteners to retail consumers, comprising the steps of: stocking numerous varieties of fasteners at a retail outlet in selected locations, each of said locations identifiable by visible retail location identifiers; providing consumers with access to a computer programmed with merchandising software, said software having a user interface for receiving user input and for displaying icons describing said fasteners and also for displaying the retail location identifiers corresponding to the locations in which said fasteners are stocked; and allowing such consumers public access to said fasteners.

Another aspect of the invention provides a system for selecting a fastener comprising: a computer having a user interface for displaying information and for receiving user input; a collection of pages capable of being displayed on said user interface, said pages including one or more selection pages and one or more detail pages, wherein some of said selection pages include icons for selecting one or more types of fasteners, and wherein each said detail page includes information describing a selected type of fastener; and display software for controlling the display of said pages on said user interface, in response to said user input.

Another aspect of the invention provides a method of selecting a fastener comprising: selecting an application in which a fastener may be used; accessing a collection of pages describing various types of fasteners; navigating through the collection of pages to identify a particular fastener suitable for the application; and selecting the particular fastener.

In one embodiment, the step of accessing the collection of pages is performed by accessing an overview main page of said collection of pages, wherein said overview main page illustrates two of more types or groups of fasteners; selecting a type or group of fastener suitable for the application; viewing another page of said collection of pages, wherein said other page illustrates additional fasteners within said type or group of fasteners; repeating the steps of selecting and viewing one or more times; and viewing a detail page of said collection page, wherein said detail includes information relating to said particular fastener.

Another aspect of the present invention provides a method of locating a particular fastener substantially similar to a sample fastener comprising: accessing a collection of pages describing various types of fasteners; navigating through the collection of pages and selecting a type of fastener; repeating the step of navigating one or more times and progressively selecting a type of fastener more closely resembling the sample fastener; and selecting the particular fastener.

Another aspect of the present invention provides a computer readable medium containing a collection of pages capable of being displayed on a user interface device, said pages including one or more selection pages for selecting a type of fastener from two or more types of fasteners and including one or more detail pages for describing selected types of fasteners, wherein said pages are organized in a tree structure having a selection page at its root node.

The present disclosure also describes a system and facility for vending and purchasing fasteners according to the present invention.

### BRIEF DESCRIPTION OF THE DRAWINGS

One embodiment of the present invention will now be described with reference to the drawings, in which:

FIG. 1 is a partially cut-away perspective view of a system according to the present invention;

FIG. 2 is an illustration of a collection of data pages forming part of the system of FIG. 1;

FIG. 3 illustrates an overview main page of the system of FIG. 1;

FIG. 4 illustrates a Bolts main page of the system of FIG. 1;

FIG. 5 illustrates a Hex Bolts-UNC Grade 2 page of the system of FIG. 1;

FIG. 6 illustrates a Carriage Bolt: Plated Steel page of the system of FIG. 1;

FIG. 7 illustrates a Carriage Bolt: Hot Dipped Galvanized page of the system of FIG. 1;

FIG. 8 illustrates a Wood Screws main page of the system of FIG. 1;

FIG. 9 illustrates an Anchors: Hollow Wall page of the system of FIG. 1;

FIG. 10 illustrates a frame of a video demonstration included in the system of FIG. 1;

FIG. 11 illustrates a Hollow Wall Anchor page of the system of FIG. 1;

FIG. 12 illustrates a Hard-To-Find Fasteners—A page of the system of FIG. 1;

FIG. 13 illustrates a Knurled Head Nuts page of the system of FIG. 1;

FIG. 14 illustrates a Knurled Head Screws page of the system of 1;

FIG. 15 illustrates a Hard-To-Find Fasteners—B page of the system of FIG. 1; and

FIG. 16 illustrates a method according to the present invention.

### DETAILED DESCRIPTION OF EXEMPLARY EMBODIMENTS OF THE INVENTION

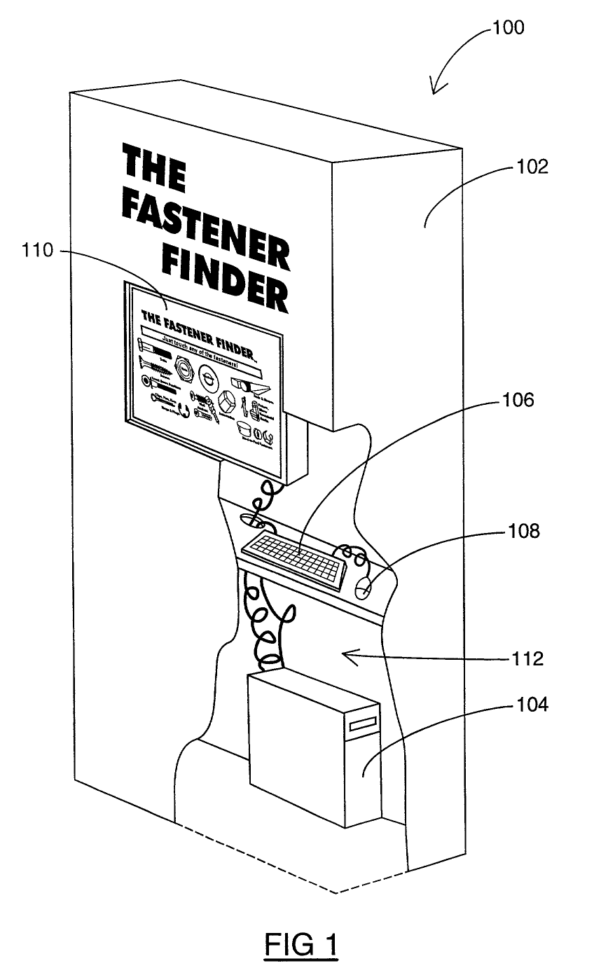

Reference is first made to FIG. 1, which illustrates a system 100 which may be installed in a home improvement center or other retail establishment at which fasteners and other related products are sold. System 100 is designed for use by a retail consumer to learn which types of fasteners are available at that particular retail establishment, how the fasteners may be used, and where they are located in the store.

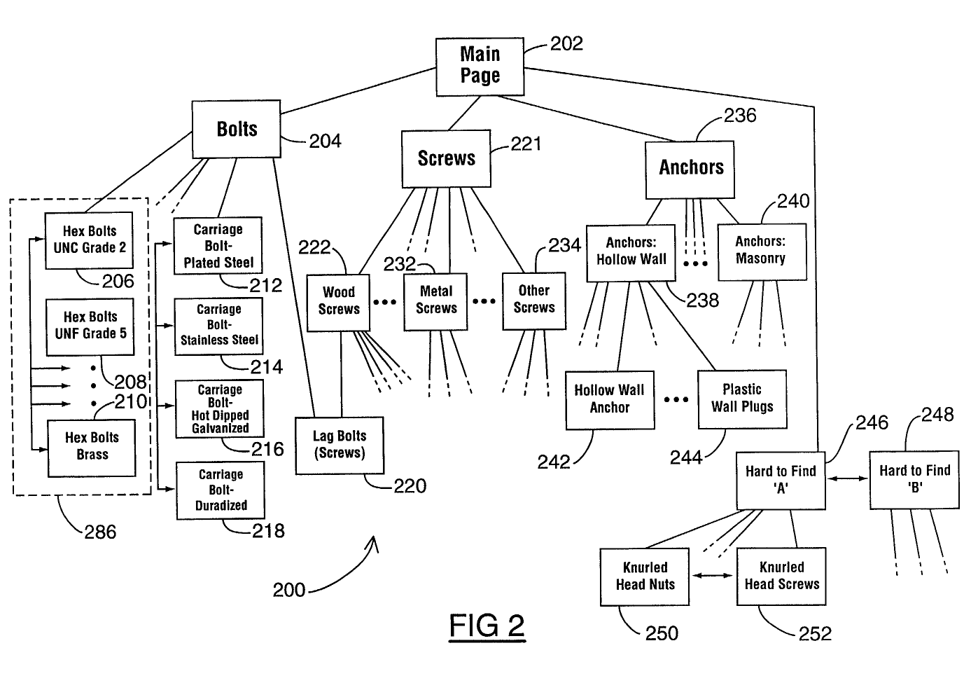

System 100 has a housing 102, and a computer system 112. Computer system 112 comprises a computer 104, a keyboard 106, a mouse 108, and a display screen 110, which are coupled together in a conventional manner. Computer system 112 is enclosed with housing 102. The only component of computer 112 which is visible from the exterior of housing 102 is the front side of display screen 110. Computer 104 contains a conventional data storage device (not shown) such as a hard disk drive or a CD ROM drive is capable of storing computer software and data. A collection of data pages 200 (FIG. 2) and software (not shown) for displaying the data pages 200 is recorded on a medium accessible by computer 104. In the preferred embodiment of system 100, data pages 200 and the associated software are recorded on a CD-ROM which is installed in a CD-ROM drive installed in computer 104. Alternatively, data pages 200 and the associated software may be recorded on a hard disk drive of computer 104 or may be accessible through a local or other computer network, such as a LAN or the Internet.

Display screen 110 of computer system 112 may comprise a touch screen, which may be used simultaneously for displaying data to a user and for receiving input from the user. Alternatively, the display screen 110 of computer system 112 may be a conventional computer display monitor, and a separate input device, such as mouse 108, may be accessible from the outside of housing 102 to allow the user to provide input to computer system 112. In the preferred embodiment of the present invention, display screen 110 is a touch screen and will be referred to as a touch screen 110.

Retail consumers visiting a retail establishment equipped with system 100 may approach system 100 and, using touch screen 110, use a software program executing on computer 104. Keyboard 106 and mouse 108 are accessible to a manager of computer system 112 by opening a panel of housing 102. The computer manager may use these input devices to operate computer system 112 in the known manner.

Reference is next made to FIG. 2, which illustrates a collection of data pages 200 that are recorded on a storage medium installed in computer 104. In the preferred embodiment of system 20, data pages 200 are HTML format pages suitable for use with any conventional World Wide Web browser, such as the well known Microsoft Internet Explorer (a trademark of Microsoft Corporation) or Netscape Navigator (a trademark of Netscape Communications Corporation) browsers. In an alternative embodiment of system 20, data pages 20 may be in another graphical formation (i.e. JPEG and/or AVI files, etc.) and may be displayed for viewing by the user using any suitable software.

Data pages 200 are organized in a tree structure which allows any particular page 200 to be accessed by traversing one or more pages 200 above it. Data pages 200 may be divided into two general groups. The first group is “selection pages”, which allow the user to select one out of numerous different types or groups of fasteners. The second group is “detail pages”, which provides information about a type or group of fasteners. Making a selection on a selection page causes either another selection page or a detail page to be displayed on touch screen 110. In general, once the user has reviewed a detail page, the user will return to the selection page which led to the detail page or return back to the main page. In general, the last page or pages in each branch of the tree shown in FIG. 2 is a detail page while the preceding pages (i.e. up to the main page) are selection pages.

The detail pages provide information about a specific type of fastener. This information may include the appropriate use for the particular fastener, caveats as to conditions in which the fastener should not be used, the location at which the fastener is displayed in the retail establishment, and a description of the container in which the fastener is stocked (such as a package or bin). Due to the large number of types of fasteners and the large number of sizes in which a fastener may be made and the number of materials from which it may be made, the detail pages have a varied structure which is appropriate to the particular information that is to be conveyed about each particular type of fastener.

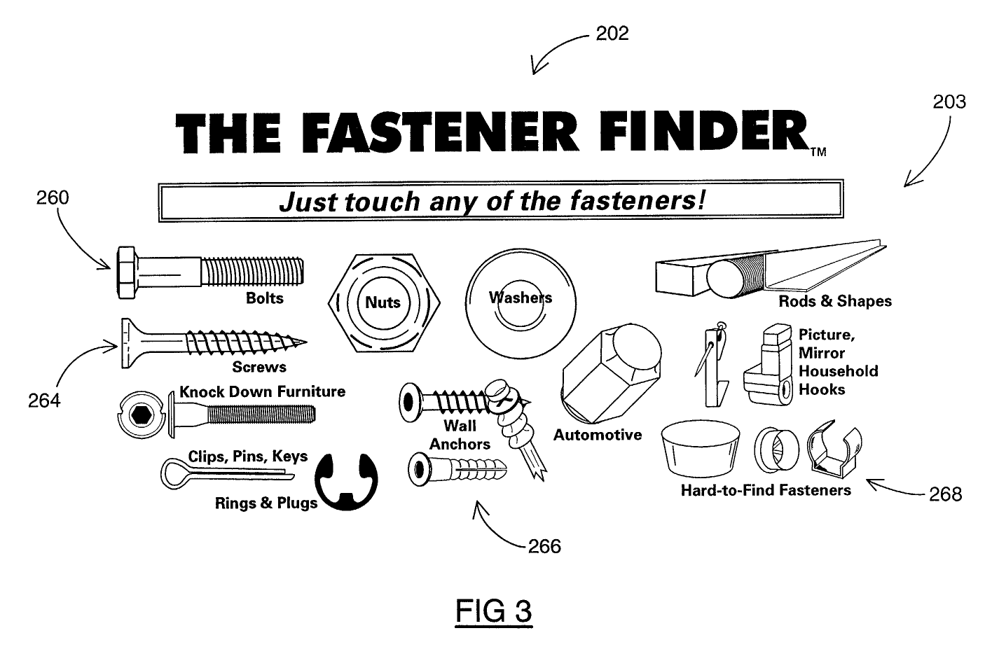

It should be noted that FIG. 2 illustrates a very small portion of the pages which actually comprise pages 200. FIG. 2 illustrates parts of four general categories which are represented on the overview main page 202 (FIG. 3): bolts 260, screws 264, anchors 266, and hard-to-find fasteners 268. Collection 200 also includes data pages for other types of fasteners and related products illustrated on overview main page 202. The large number of selection and detail pages not shown in FIG. 2 are represented by the dashed lines extending from the various pages in FIG. 2.

At the root of the tree of pages 200 is a overview main page 202, shown in FIG. 3. Overview main page 202 is a selection page that illustrates a number of different types of fasteners which are available in the home improvement center in which system 100 has been installed. Overview main page 202 will normally be displayed on the display screen 110 of computer system 112, when computer system 112 is not in use by a user.

Overview main page 202 includes a number of Fastener Type icons 203. Each Fastener Type icon 203 represents a class of fasteners that share a common use or characteristic. Each Fastener Type icon 203 consists of a graphical image of a representative fastener selected from the class and a word or phrase describing the class. For example, Fastener Type icon 260 represents bolt-type fasteners and appears as an exemplary bolt and the word “bolts”. One skilled in the art will recognize that main page 202 and other pages 200 may have different layouts. For example, the position and appearance of icons on each page may be varied. Additional icons may be added to represent additional fastener types, or some icons may be removed. Finally, the icons may be of any form, and may not include graphical components. The icons may simply be text icons.

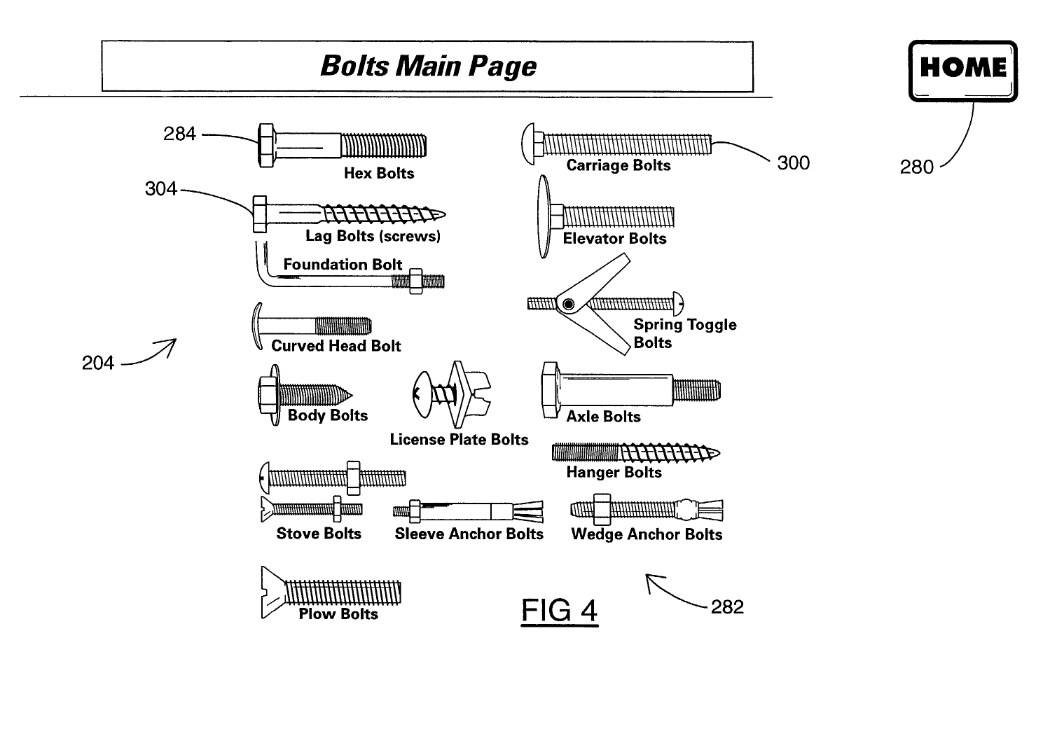

The usage and structure of some exemplary data pages 200 will now be explained. If a user selects Fastener Type icon 260 on overview main page 202 by touching Fastener Type icon 260, a Bolts main page 204 (FIG. 4) is displayed on touch screen 110. Bolts main page 204 has a home button 280 and shows a number of different types of Bolt icons 282. The user may select home button 280 to return to overview main page 202 on this or any other page 200.

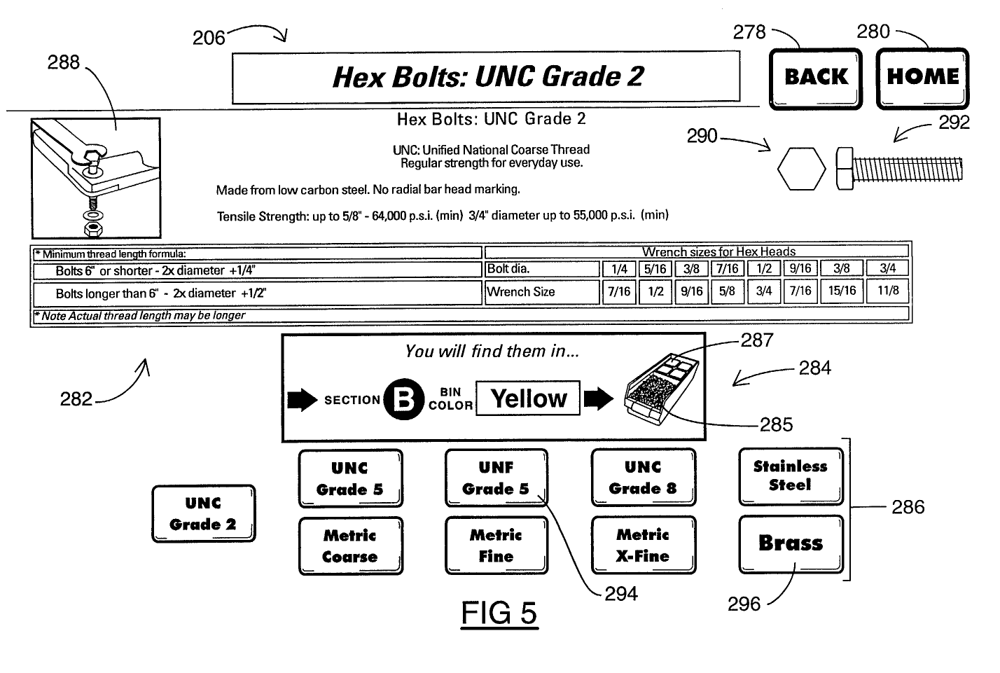

The user may select any of the Bolt icons 282 to see a detail page describing the selected type of bolt. For example, the user may select a Hex Bolt icon 284. Referring to FIG. 2, data pages 200 includes a number of different pages 286 which relate to Hex Bolts including a Hex Bolts-UNC Grade 2 page 206 (FIG. 5), a Hex Bolts-UNF Grade 5 page 208 and a Hex Bolts-Brass page 210. When a user selects Hex Bolts icon 284, Hex Bolts UNC Grade 2 page 206 is displayed on touch screen 110. Hex Bolts UNC Grade 2 page 206 is shown in FIG. 5. Hex Bolts UNC Grade 2 page 206 has a back button 278, a home button 280, a usage information section 282, a location/package information section 284, and a plurality of Hex Bolt Type buttons 286.

Back button 278 appears on a number of pages 200 and returns the user to the page that he was viewing prior to viewing the page currently displayed on touch screen 110. In the case of Hex Bolts-UNC Grade Two page 206, Bolts Main page 204 will be displayed if the user selects back button 278. Home button 280 operates in exactly the same way as on page 204.

Usage information section 282 provides information as to how UNC Grade 2 Hex Bolts may be used. In particular, usage information section 282 of Hex Bolts UNC Grade 2 page 206 indicates that this type of hex bolt is appropriate for every day use and indicates the wrench size required for use with hex heads of different sizes, in addition to other information. Usage information section 282 also includes an illustration 288 showing how a UNC grade 2 hex bolt may be installed. Usage information section 282 also contains graphic illustrations 290 and 292 of the head and profile of a UNC grade 2 hex bolt which the user may find helpful in identifying this type of hex bolt.

Location/package information section 284 indicates where UNC grade 2 hex bolts may be found on the shelves of the retail establishment and the containers in which they are stocked. Location/package information will be coordinated with a pre-determined system by which the retail establishment organizes its display of products. In the preferred embodiment, location information is provided in terms of letter coded sections for the aisles and shelves of the retail establishment and color codes for the package or the bin in which the fastener is stocked. In another embodiment of the present invention, location information may be based on aisle numbers and shelf numbers, etc.

Referring to the present example, location/package information section 284 indicates that UNC grade 2 hex bolts are sold in Section B of the store in yellow bins and that they are packaged in individual units 285 and in boxes 287. Hex Bolt Type buttons 286 allow the user to select a different type of hex bolt. When a particular type of hex bolt is selected by the user by touching the appropriate part of touch screen 110 an information page for the selected type of hex bolt will be displayed. For example if the user selects the UNF Grade 5 button 294 a Hex bolt-UNF Grade 5 page 208 (FIG. 2) will be displayed. Similarly if the user selects the Hex Bolt-Brass button 296 then a Hex Bolt-Brass page 210 (FIG. 2) will be displayed.

This example illustrates how a user may traverse a series of pages 200 to find specific information about a selected type of fastener. In this case, to find detailed information about brass hex bolts, starting from overview main page 202 the user must go to Bolt Main Page 204 then to Hex Bolts UNC Grade 2 main page 206 from which he may select Hex Bolts-Brass page 210. When the user initially selects a class of fasteners (i.e. hex bolts), a selected initial detail page describing one member of that class of (i.e. UNC grade 2 hex bolts) is displayed. Other detail pages for other member of the class (i.e. brass hex bolts) may be displayed by selecting a control on the initial detail page. The initial detail page will generally be chosen to be one that describes the most common member in a class of fasteners.

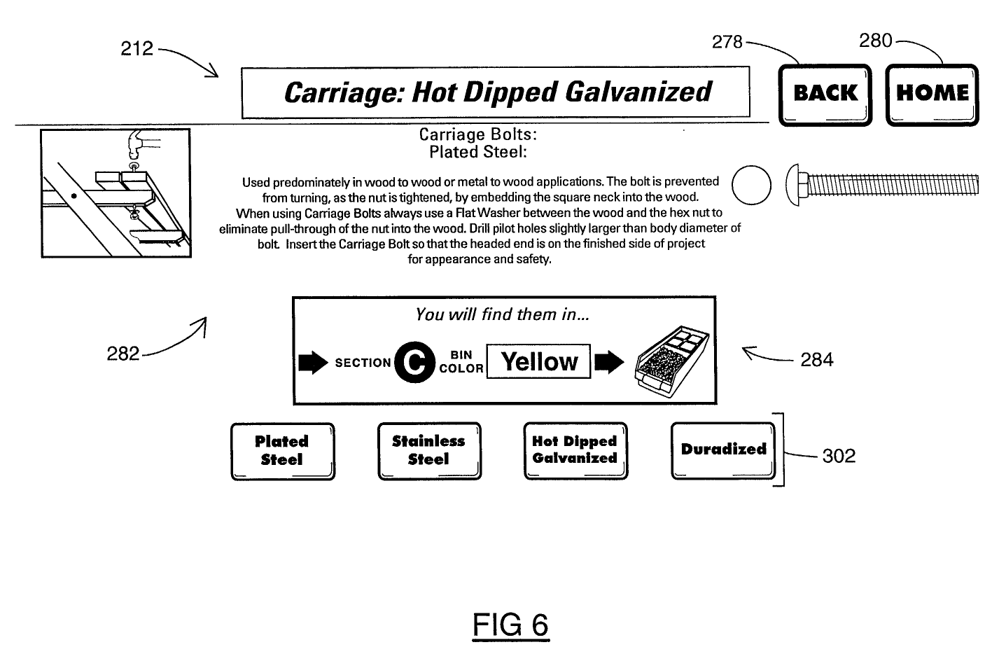

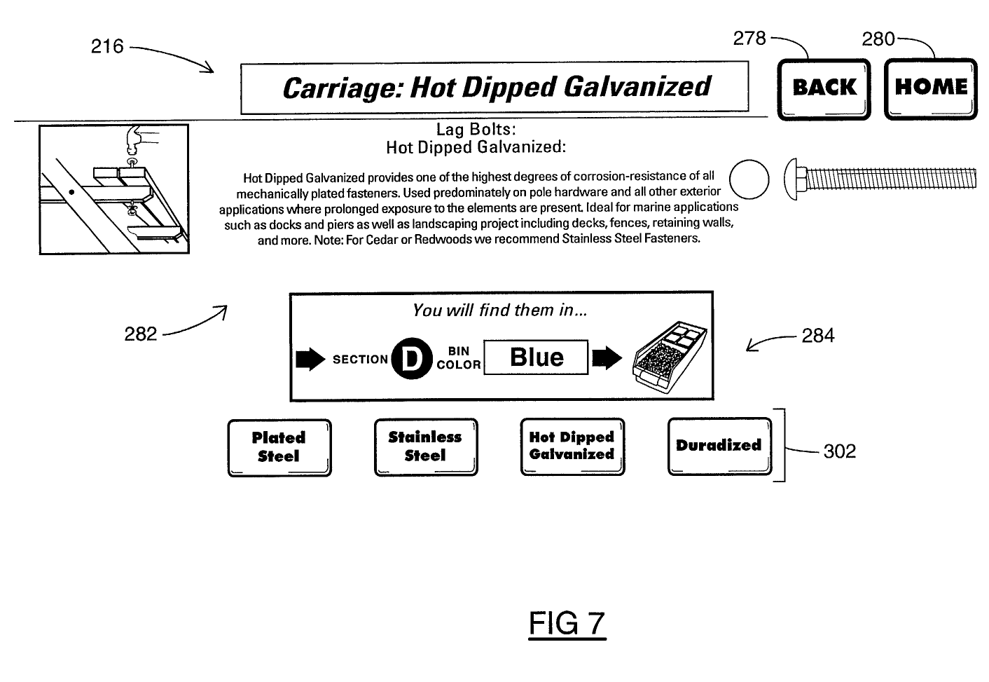

From Bolts main page 204, the user may select Carriage Bolt Icon 300. This will cause a Carriage Bolt: Plated Steel page 212 (FIG. 6) to be displayed on touch screen 110. Carriage Bolt: Plated Steel page 212 has a usage information section 282 and a location/packaging information section 284 similar to those of Hex bolt: UNC Grade 2 page 206 (FIG. 5). From Carriage Bolts: Plated Steel page 212 the user may display detail pages relating to other types of carriage bolts by selecting one of the Carriage Bolt Buttons 302. Referring also to FIG. 2, the user may display any of Carriage Bolt: Stainless Steel page 214 (FIG. 2), Carriage Bolt: Hot Dipped Galvanized page 216 (FIGS. 2 and 7), or Carriage Bolt: Duradized page 218 (FIG. 2) by selecting the appropriate Carriage Bolt Button 302.

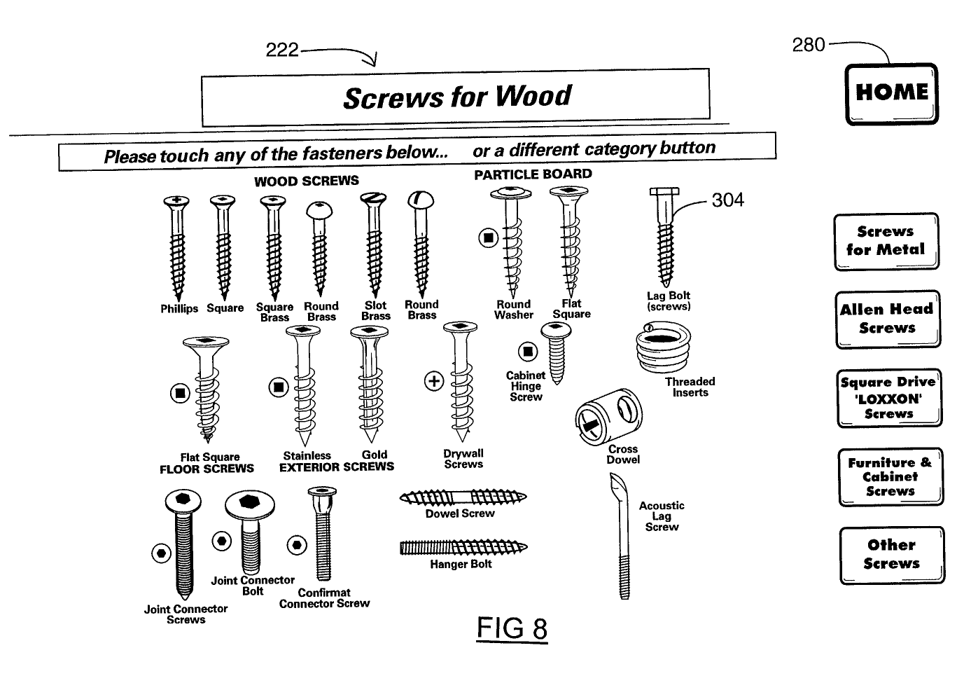

Certain types of fasteners fit into more than one of the categories of fasteners displayed on overview main page 202. For example Bolt main page 204 (FIG. 4) shows a Lag Bolts (Screws) icon 304. As indicated by its title, a lag bolt may also be considered a type of screw. In particular a lag bolt is generally a relatively large screw used to fasten an object to a piece of construction lumber. Referring to FIG. 2, pages 200 include a Lag Bolts (Screws) page 220. Lag Bolts (Screws) page 220 may be reached by selecting Lag Bolts (Screws) icon 304 on Bolts main page 204. Lag Bolts (Screws) page 220 may also be reached by selecting Screws icon 264 from overview main page 202. This will cause a Screws main page 221 to be displayed. Screws main page 221 includes icons for wood screws, metal screws, and other screws (Screws main page 221 is not shown in detail.) If the Wood Screws icon is selected, a Wood Screws main page 222 (FIG. 8) will be displayed. Wood Screws main page 222 also includes Lag Bolt (Screws) icon 304 and selecting this icon will also cause Lag Bolts (Screws) page 220 to be displayed on touch screen 110.

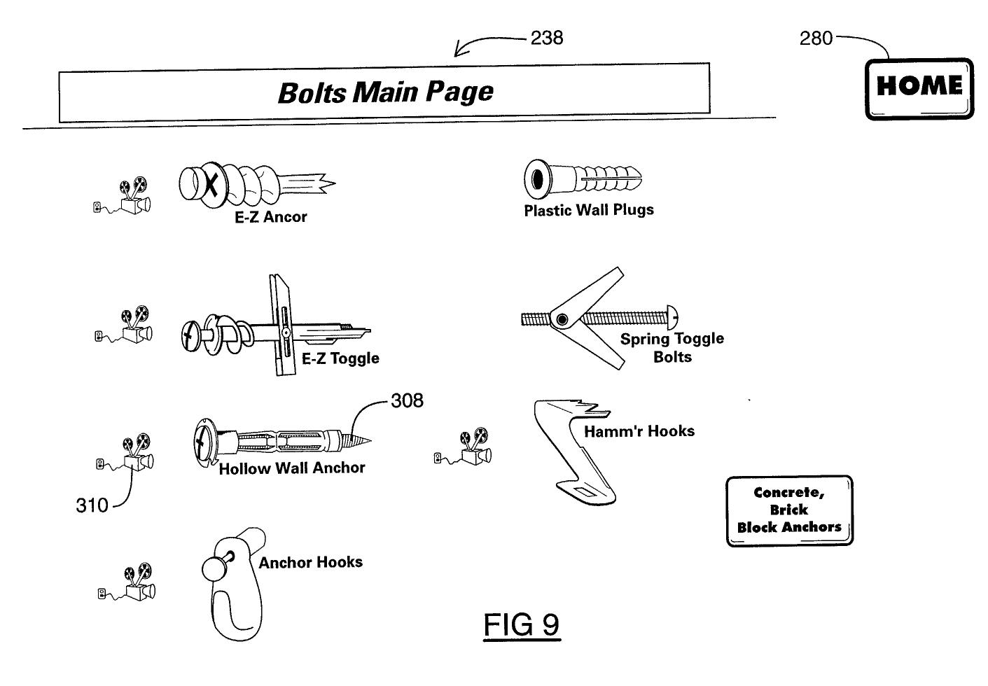

In addition to the usage information 282 and location/package information 284 provided on most detail pages 200, additional types of information may be provided. Referring to FIG. 2, if the user selects Wall Anchors icon 266 on overview main page 202, an Anchors main page 236 is shown. Anchors main page 236 (shown only in FIG. 2) has Anchor Type icons (not shown) representing different types of anchors, including hollow wall anchors and masonry anchors. If the user selected a Masonry Anchors icon, an Anchors: Masonry page 240 (FIG. 2) is displayed on touchscreen 110. If the user selects a Hollow Wall Anchors icon on Anchors Main Page 236 an Anchors: Hollow Wall page 238 (FIGS. 2 and 9) is displayed on touchscreen 110.

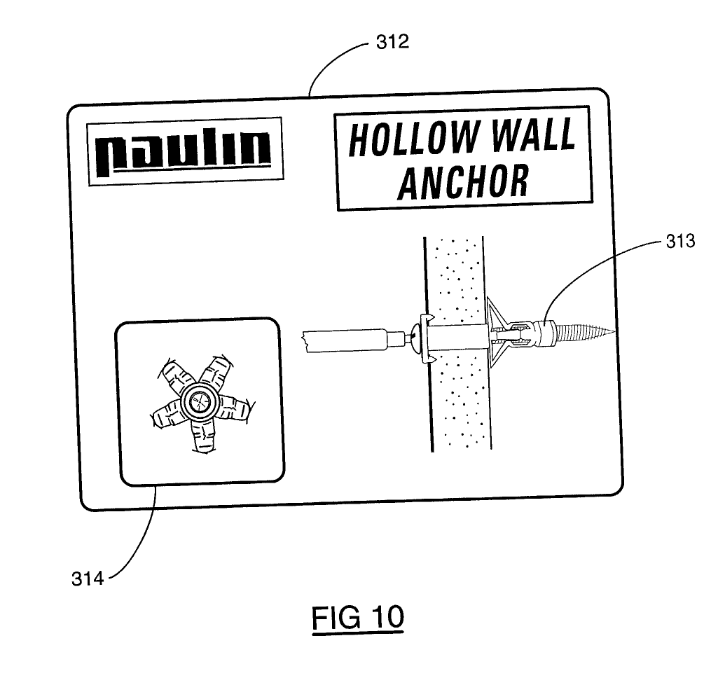

Anchors: Hollow Wall page 238 has a number of icons for specific types of hollow wall anchors, including an HWA icon 308 for one type known simply as the “Hollow Wall Anchor”, which is suitable for installation in drywall. Beside HWA icon 308 a Video Demonstration icon 310 is displayed. If the user selects Video Demonstration icon 310, a video demonstration 312 (FIG. 10) is played. FIG. 10 shows a frame from video demonstration 312. Video demonstration 312 illustrates the tools required to ;install a hollow wall anchor, how a hollow hall anchor is positioned in the correct location and how it is installed, from the exterior of the hollow wall in to which the Hollow wall anchor is being installed. In addition, a window 314 in video demonstration 312 illustrates the operation of a hollow wall anchor from the interior of the wall.

Video Demonstration icon 312 is also displayed on Anchors: Hollow Wall page 238 beside other icons associated with specific types of hollow wall anchors. A user may view a video presentation relating to each of these hollow wall anchors by selecting the corresponding video demonstration icon 312.

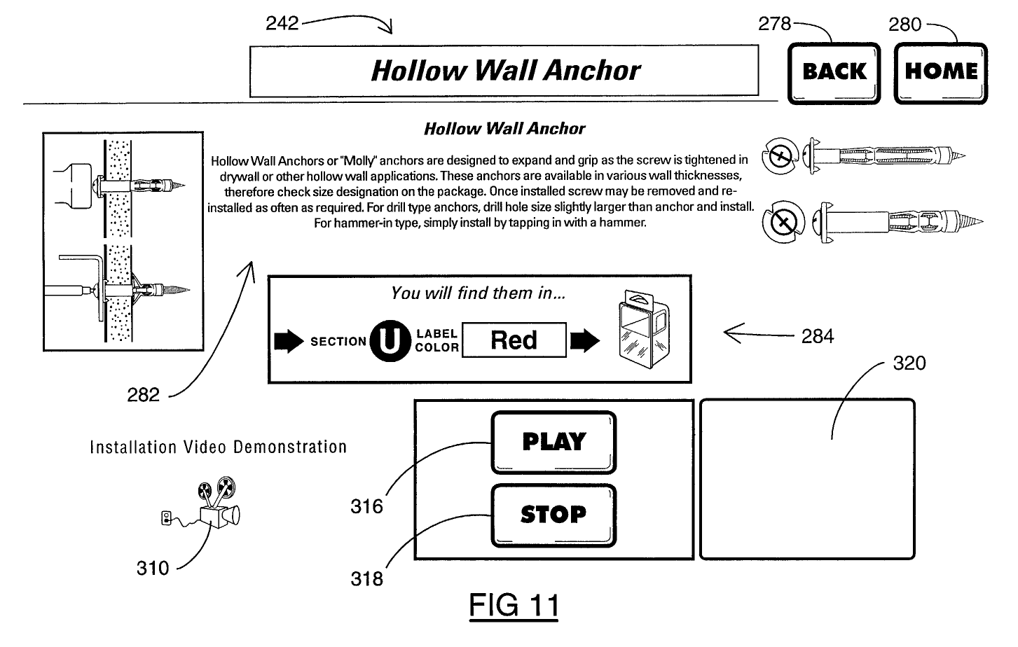

If a user selects HWA icon 308, a Hollow Wall Anchor page 242 (FIG. 11) is displayed on touchscreen 110. Hollow Wall Anchor page 242 includes back button 278, home button 280, usage information section 282 and location/package information section 284. Location/package information section 284 indicates the Hollow Wall Anchor is displayed in Section U of the retail establishment and is stocked in plastic packages having red labels.

In addition to this information, Hollow Wall Anchor page 242 also displays Video Demonstration icon 310, a play button 316, a stop button 318 and has a video display area 320. The user may view video demonstration 312 by selecting Video Demonstration icon 310 or by selecting play button 316. Video demonstration 312 is displayed in video display area 320. While video demonstration 312 is playing, the user may stop it by selecting stop button 318 and may restart it by selecting play button 316.

Video demonstration 312 is only one example of the type of additional information which may be provided to the user. Other types of information include a multimedia demonstration including sound (i.e. a voice explanation of the installation and usage of the fastener), a 3-D user controllable video, etc.

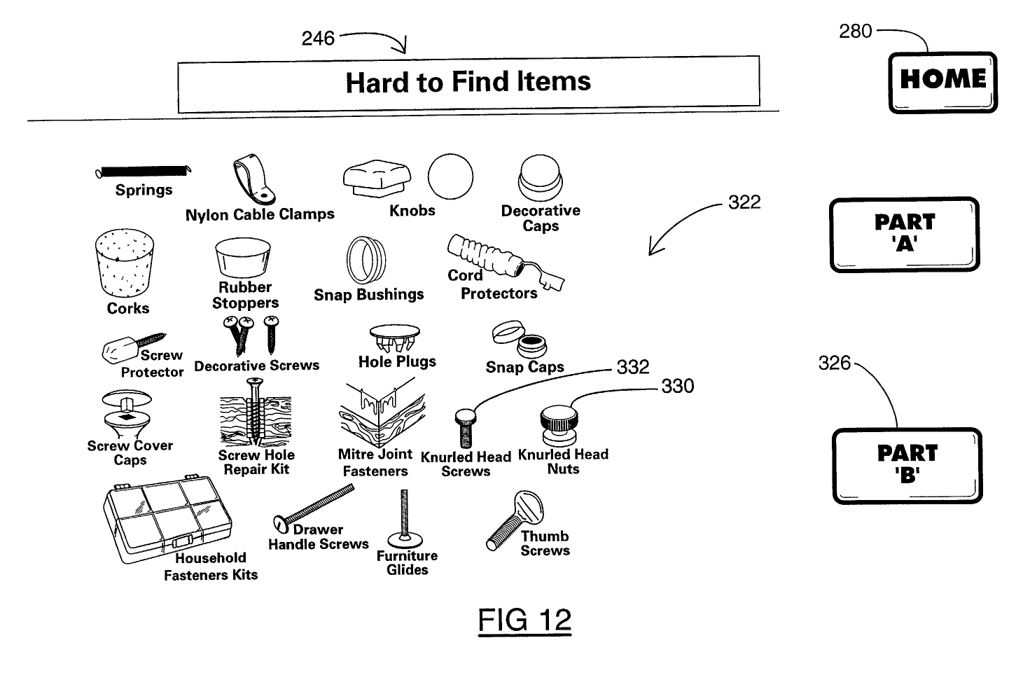

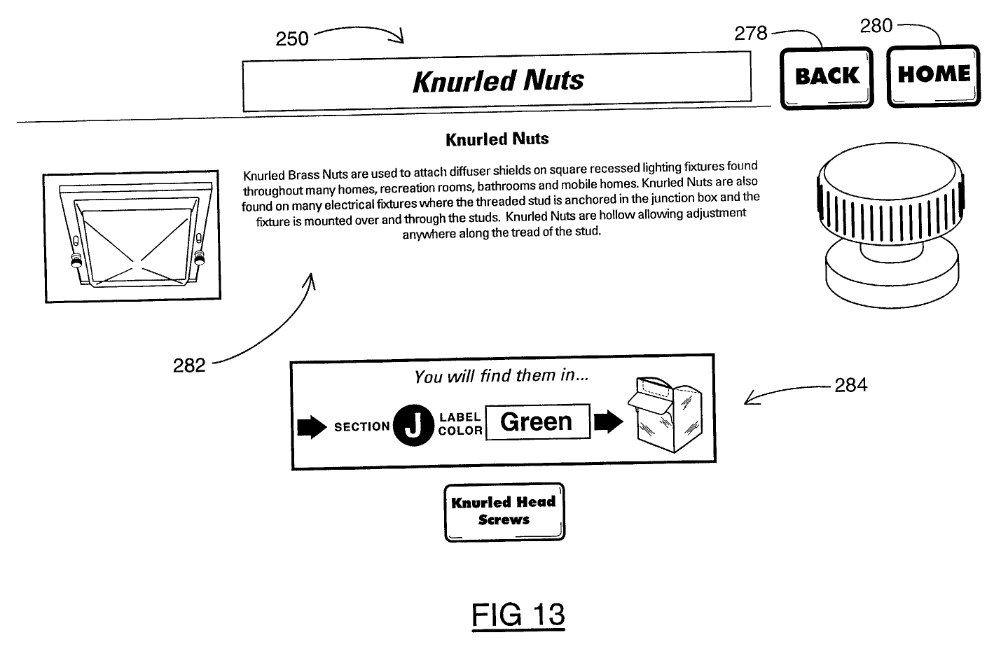

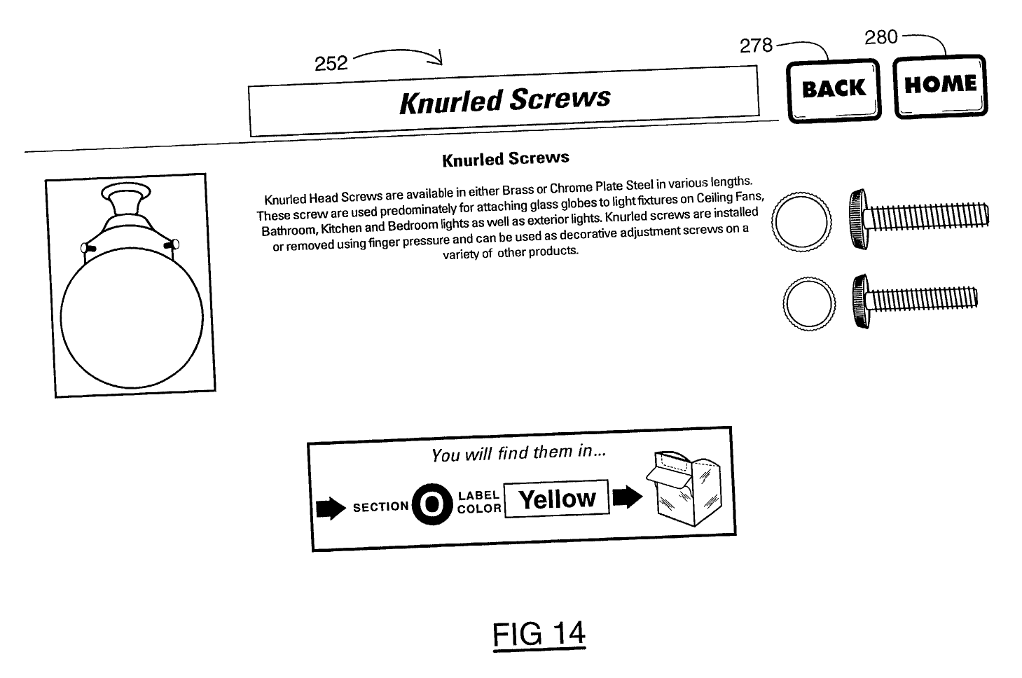

Reference is again made to FIG. 2. Some of the general categories of fasteners shown in FIG. 2 may contain too many types of fasteners to show on a single page. If the user selects Hard-To-Find Fasteners icon 268, a Hard-To-Find Fasteners—A page 246 (FIG. 12) is displayed on touchscreen 110. Hard-To-Find Fasteners—A page 246 includes a plurality of icons 322 representing various types of fasteners and additionally has a Part ‘B’ button 248. If the user selects one of the icons 322, an associated fastener detail page will be displayed. For example, the user may select Knurled Head Nuts icon 330 to display a Knurled Head Nuts page 250 (FIG. 13) or Knurled Head Screws icon 332 to display a Knurled Head Screws page 252 (FIG. 14).

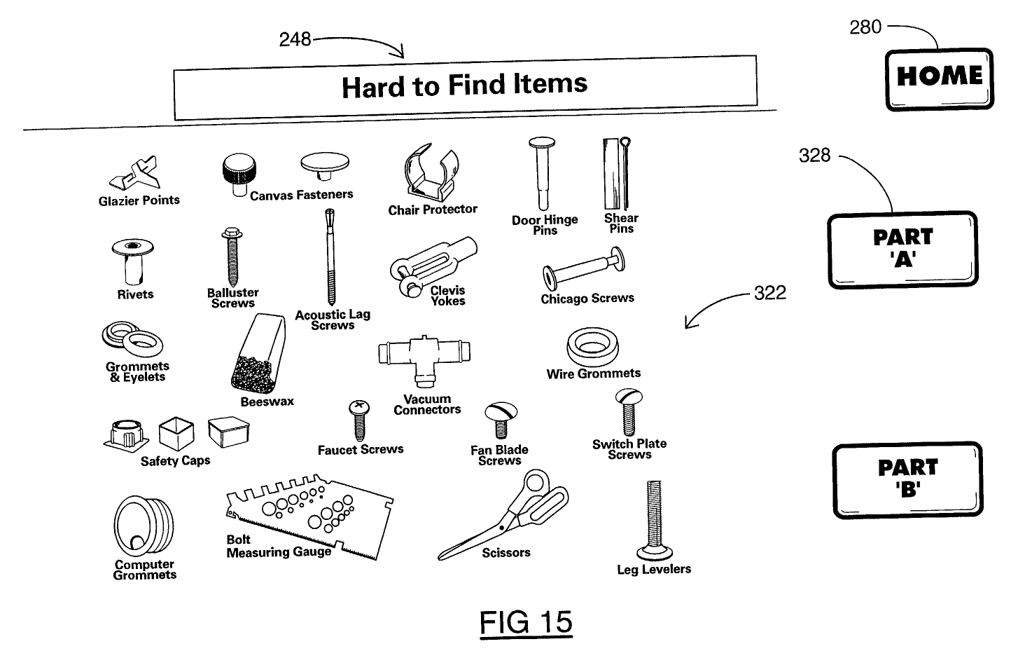

If the user selects Part ‘B’ button 326, a Hard-To-Find Fasteners—B page 248 (FIG. 15) is displayed. Hard-To-Find Fasteners—B page 248 has additional icons 322 which may be selected to display an associated fastener detail page. Hard-To-Find Fasteners—B page 248 also has a Part ‘A’ button 328 which may be used to display Hard-To-Find Fasteners—A page 246.

System 20 allows a retailer of fasteners to provide a simple to use and efficient method for allowing retail consumers to determine which fastener the user requires, how to properly use that fastener, where it is displayed in the retailer's establishment and how it is packaged. The system therefore allows a retail consumer who is unfamiliar with fastener products or with a particular retail outlet to select an appropriate fastener and to be able to locate it readily for self-serve shopping, thereby reducing or eliminating the need for consumers to consult with the retailer's staff.

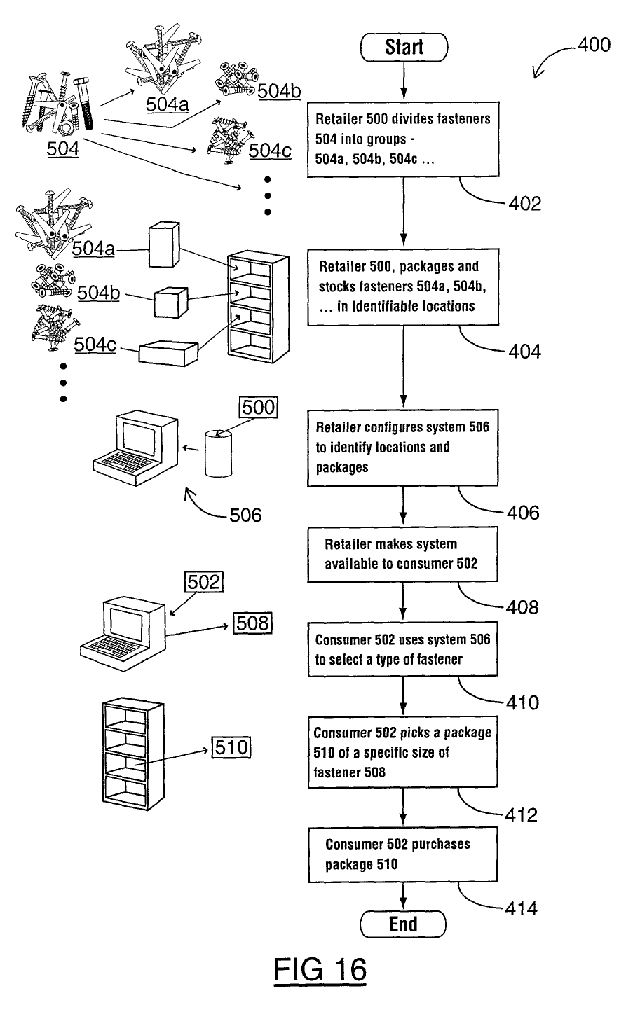

Reference is next made to FIG. 16, which illustrates a method 400 by which a retailer 500 who operates a retail establishment 501 may vend fasteners and by which a consumer 502 may purchase fasteners.

Method 400 begins in step 402 in which retailer 500 provides a plurality of fasteners 504, which includes different types and sizes of fasteners appropriate for different uses. Retailer 500 divides fasteners 504 into various groups of fasteners 504a , 504b , 504c , . . . based on the type of each fastener, the size of each fastener, the material from which each fastener is made and any other criteria the retailer considers to be relevant.

Method 400 next proceeds to step 404, in which retailer 500 packages each group of fasteners 504a , 504b , 504c , . . . and organizes the packages of fasteners on the display shelves, racks and bins, etc. of his retail establishment 501. In this step, retailer 500 also marks the specific or general location at which each group of fastener is located in the store in an identifiable way. This may be done, for example, by dividing the retail establishment into sections and dividing each section into color zones. Within each color zones, the bins in which fasteners are stored will have the same color and/or the labels on packages of fasteners may will have a section with the same color (i.e. a colored dot on the label). Alternatively, this may be done by number each aisle in the establishment and then dividing each aisle into sections.

Retailer 500 may mix steps 402 and 404. For example, the retailer may order fasteners 504 pre-packaged based on their type, size and/or material from a supplier and pre-labelled with color coded labels. The retailer may then easily stock the packages in the appropriate location of his establishment 501. If the retailer wishes to sell individual fasteners as well as packages, the retailer may order the loose fasteners, or may simply open a package of fasteners and put the loose fasteners in the same location as complete packages.

Method 400 next proceeds to step 406 in which retailer 500 configures a system 506 (which is similar to system 20 described above, except for the content of its pages 200) to have selection pages which allow the consumer 502 to select the different groups of fasteners 504a , 504b , 504c , . . . and to have detail pages which describe the usage, location and packaging of each group of fasteners.

Method 400 next proceeds to step 408 in which retailer 500 makes system 506 available to consumer 502 at establishment 501. This may be done by installing system 506 in establishment 501, preferably in a location which is easily accessible to consumer 502 and other customers.

Method 400 next proceeds to step 410 in which consumer 502 uses system 506 to select a type of fastener. Consumer 502 may traverse the various pages of system 506 to learn about different types of fastener stocked by retailer 500 and may select a fastener suitable for his needs, based on the exemplary images of different fasteners shown as part of the icons on the selection pages of system 506 and based on the usage information provided on the detail pages of system 506. Consumer 502 may bring a sample fastener with him to establishment 501 and may use system 506 to select a matching fastener from those stocked by retailer 500. When consumer 502 has selected a type of fastener 508 consumer 502 may note the location and packaging information for the selected type of fastener 508 from the detail page for that type of fastener. For example, the type of fastener 508 may be a plated steel carriage bolt.

Method 400 next proceeds to step 412 in which the consumer 502 goes to the location identified of the detail page for the type of fastener 508 that he or she selected in step 410. Consumer 502 then selects a specific size of this type of fastener from those stocked by retailer 500 and picks one or more packages 510 of this size.

Method 400 next proceeds to step 414 in which consumer 502 takes packages 510 to a purchasing station (which may be a point-of-sale terminal staffed by a sales clerk) and purchases packages 510.

Method 400 allows retailer 500 to vend fasteners 504 more easily by allowing consumers to obtain usage and location information for a desired fastener from system 506. Method 400 allows consumers to purchase fasteners 504 more easily without having to seek out a sales clerk, before they actually purchase the desired fastener. Furthermore, system 506 may provide more information about some fasteners than a clerk may be able to provide, especially if the fastener is uncommon or if the clerk is inexperienced.

Other embodiments of the present invention may have additional features.

Another embodiment of a system and method according to the present invention may display images of fasteners showing their actual dimensions. This will allow a user to compare a sample fastener that they have brought to a retail establishment with images on the screen to assist the user in selecting an identical fastener. Such an embodiment may provide detailed fastener size information in addition to usage information. For example, a fastener with the minimum (or maximum or some intermediate) shaft diameter may initially be displayed in actual size, in a cross-sectional view. The user may then compare the diameter of the sample fastener to that displayed and use controls on the screen to display larger and smaller fasteners until the user is able to select the correct shaft diameter. The system may then display a side profile of the shortest (or longest or some intermediate) fastener having that shaft diameter. The user may then select a control icon to display longer and shorter fasteners until the correct fastener is located. As each such fastener is displayed, information relating to its use and location in the store may be displayed.

An embodiment which provides detailed fastener size information may also provide stock and price information for each size and each type of fastener. For example, the detail page relating to plated steel carriage bolts may indicate that ¼″×5″ plated steel carriage bolts are out of stock and will be available in three days. The detail page may also indicate that ½″×8″ carriage bolts are sold for 70 cents each or $5.00 for 10. The detail page identifies the package with the lowest unit price as a “Best Buy”. If such a system is implemented by a retailer that operates a chain of retail establishments, the detail page may also identify another establishment where an out-of-stock product is still available. This last feature is most suitable for a system in which pages 200 are displayed via a network. Such a system is described below.

In another embodiment of a system and method according to the present invention, copies of pages 200 and the software required to view them may be distributed to users for home use. This may be done by providing a copy of each on a pre-recorded storage medium such as CD ROM or by allowing the user to download pages 200 and the required software from a distribution site via a network such as the Internet. In such a system, the location/package information may be particularized for multiple retail establishments that are part of a chain of such establishments. The user may configure the software to display the location/package information for one or more selected stores, which are located near the user. Such an embodiment may also indicate if a particular fastener is not available in a particular establishment.

In another embodiment of a system and method according to the present invention, pages 200 may be stored at a remote computer, and the computer system 112 may consist only of a terminal capable of displaying pages 200. In such an embodiment multiple computer systems 112 may be connected to the remote computer and may be able to simultaneously display pages 200 according to input received from users at each separate terminal. Such terminals may be located in retail establishments or in the homes of users or both. For example, the pages 200 may be located on a web site and any Internet user may be permitted to display them on his own computer. In this embodiment, real time stock information for each type of fastener in each of the retail establishments may be displayed for each fastener.

In some cases a retailer will obtain all or most of the fastener products stocked in his establishment from a single fastener supplier. In one embodiment of the invention, the retailer and the fastener supplier may cooperate to provide system 20 such that fastener supplier 20 provides the usage information on detail pages and the retailer provides the location information. Both the fastener supplier and the retailer may provide packaging information. Such a system is helpful to both the retailer and the fastener supplier to increase the sales of their products. Making these and other embodiments of the present invention will be within the competence of the person skilled in the art and fall within the spirit and scope of the present invention, which is limited only by the following claims.

We claim:

1. A method of vending fasteners to retail consumers, comprising the steps of:
(a) stocking numerous varieties of fasteners at a retail outlet in selected locations, each of said locations identifiable by visible retail location identifiers;
(b) providing consumers with access to a computer programmed with merchandising software, said software having a user interface for receiving user input and for displaying icons describing said fasteners and also for displaying the retail location identifiers corresponding to the locations in which said fasteners are stocked; and
(c) allowing such consumers public access to said fasteners.

2. The method of claim 1, wherein said fasteners are stocked in pre-determined containers, readily identifiable by visible container identifiers, and wherein said container identifiers are displayed on said user interface.

3. The method of claim 1, wherein said icons include graphical images of said fasteners.

4. The method of claim 3, wherein said icons, information, and retail location identifiers and container identifiers are presented on pages organized according to fastener varieties, and wherein said user input determines the display of said pages.

5. The method of claim 4, wherein said user interface includes a screen for displaying videos demonstrating the use of at least some of said fasteners.

6. The method of claims 1, 2, 3 or 4, wherein step (b) is carried out at said retail outlet, and wherein said user interface includes a touch screen.

7. The method of claim 1, wherein step (b) is carried out remote from said retail outlet, and wherein said user interface includes personal computer and monitor.

8. The method of claim 7, wherein said software is provided to said consumers on a pre-recorded storage medium.

9. The method of claim 7, wherein said software is provided to said consumers by means of a computer network.

10. The method of claim 9 wherein said software comprises a series of pages capable of being displayed by a network browser.

11. A system for selecting a fastener comprising:
(a) a computer having a user interface for displaying information and for receiving user input;
(b) a collection of pages capable of being displayed on said user interface, said pages including one or more selection pages and one or more detail pages, wherein some of said selection pages include icons for selecting one or more types of fasteners, and wherein each said detail page includes information describing a selected type of fastener; and
(c) display software for controlling the display of said pages on said user interface, in response to said user input.

12. The system of claim 11 wherein said information on includes the location of said selected type of fastener in a retail establishment.

13. The system of claim 12 wherein said information includes stock information relating to the availability of said selected type of fastener in said retail establishment.

14. The system of claim 11 wherein said information includes the location of said selected type of fastener in two or more retail establishments.

15. The system of claim 11 wherein some of said detail pages include a link for displaying real-time information relating to the availability of the associated selected type of fastener.

16. The system of claim 11 wherein said information includes graphical instructions describing appropriate usage of said selected type of fastener.

17. The system of claim 11 wherein said information includes a video demonstrating usage of said selected type of fastener.

18. A method of selecting a fastener suitable for a particular purpose from a collection of numerous varieties of fasteners comprising:
(a) identifying an application in which a fastener may be used;
(b) accessing a collection of pages by using a computer, the collection of pages describing various types of fasteners;
(c) navigating through the collection of pages to identify a particular fastener suitable for the application; and
(d) choosing an appropriate fastener therefrom.

19. The method of claim 18 wherein step (c) is performed by:
(i) accessing an overview main page of said collection of pages, wherein said overview main page illustrates two of more types or groups of fasteners;
(ii) selecting a type or group of fastener suitable for the application;
(iii) viewing another page of said collection of pages, wherein said other page illustrates additional fasteners within said type or group of fasteners;
(iv) repeating steps (ii) and (iii) one or more times; and
(v) viewing a detail page of said collection page, wherein said detail includes information relating to said particular fastener.

20. The method of claim 19 wherein said detail page includes information relating to the location of said particular fastener in a retail establishment.

21. The method of claim 19 wherein said detail page includes information relating to the availability of said particular fastener in a retail establishment.

22. The method of claim 21 wherein said information includes real-time stock information about said particular fastener in one or more retail establishments.

23. The method of claim 20 wherein steps (b) and (c) are performed in the retail establishment.

24. The method of claim 20 wherein step (b) and (c) are performed in a location remote from said retail establishment.

25. The method of claim 24 further including the following step:
(e) attending at the location of the particular fastener, obtaining one or more of the particular fastener and purchasing the obtained fasteners.

26. The method of claim 24 wherein steps (b) and (c) are performed using a network browser.

27. A method of locating a particular fastener substantially similar to a sample fastener comprising:
(a) accessing a collection of pages by using a computer, the collection of pages describing various types of fasteners;
(b) navigating through the collection of pages and selecting a type of fastener;
(c) repeating step (b) one or more times and progressively selecting a type of fastener more closely resembling the sample fastener; and
(c) selecting the particular fastener.

28. The method of claim 27 wherein step (b) is performed by
(i) comparing a characteristic of the sample fastener with a fastener displayed on a page;
(ii) selecting the next page to be displayed based on the results of the comparison in step (i); and
(iii) selecting the particular fastener when displayed fastener most closely resembles the sample fastener.

29. The method of claim 28 wherein the following steps are performed before step (ii):
(iv) comparing a second characteristic of the sample fastener with a fastener displayed on a page; and
(v) selecting the next page to be displayed based on the the result of the comparison in step (iv).

30. A computer readable medium containing a collection of pages capable of being displayed on a user interface device, said pages including one or more selection pages for selecting a type of fastener from two or more types of fasteners and including one or more detail pages for describing selected types of fasteners, wherein said pages are organized in a tree structure having a selection page at its root node.

31. The computer readable medium of claim 30 wherein each of said selection pages includes one or more icons, each of said icons being associated with one or more associated pages, wherein said associated pages may be selection pages or detail pages.

32. The computer readable medium of claim 30 wherein at least some of detail pages contain information relating to one type of fastener.

33. The computer readable medium of claim 32 wherein each of said detail pages includes a description of the location of said type of fastener in a retail establishment.

34. The computer readable medium of claim 33 wherein said location is publicly accessible.

35. The computer readable medium of claim 32, wherein said information includes the availability of said type of fastener in one or more retail establishments.

36. The computer readable medium of claim 35, wherein at least some of said detail page include a link for displaying real time stock information for said type of fastener, wherein said real time stock information is located in a database.

37. The computer readable medium of claim 36 wherein said database is stored on a remote data medium.
